(19) United States
(12) Patent Application Publication
(10) Pub. No.: US 2011/0080817 A1
(43) Pub. Date: Apr. 7, 2011

(54) COMPATIBLE OPTICAL PICKUP AND OPTICAL INFORMATION STORAGE MEDIUM SYSTEM EMPLOYING THE SAME

(75) Inventors: Jae-cheol Bae, Suwon-si (KR); Tae-kyung Kim, Seoul (KR); Kyong-tae Park, Suwon-si (KR); Woo-seok Choi, Seoul (KR)

(73) Assignee: SAMSUNG ELECTRONICS CO., LTD., Suwon-si (KR)

(21) Appl. No.: 12/964,674

(22) Filed: Dec. 9, 2010

Related U.S. Application Data
(62) Division of application No. 12/016,399, filed on Jan. 18, 2008.

(30) Foreign Application Priority Data
Feb. 23, 2007 (KR) 2007-18517

(51) Int. Cl. G11B 7/12; G11B 7/00

(52) U.S. Cl. 369/47.49; 369/103; G9B/7; G9B/7.097

(57) ABSTRACT

An optical pickup compatible with different types of optically recorded media and an optical recording and/or reproducing system employing the compatible optical pickup, the compatible optical pickup including: a short wavelength light source emitting a short wavelength light; a low-density optical system emitting a long wavelength light; an objective lens focusing lights incident from the long wavelength light source and the low-density optical system onto an information storage medium; a single photodetector (PD) receiving the short and long wavelength lights reflected from the information storage medium; a detection lens focusing the short and long wavelength lights reflected from the information storage medium as a light spot onto the single PD; a first collimating lens positioned on an optical path of a light reflected, wherein the optical path is positioned between the objective lens and the single PD; and a driving unit adjusting a position of the first collimating lens.

### CROSS-REFERENCE TO RELATED APPLICATIONS

This application is a divisional of U.S. application Ser. No. 12/016,399, filed on Jan. 18, 2008, which claims the benefit of Korean Application No. 2007-18517, filed on Feb. 23, 2007, in the Korean Intellectual Property Office, the entire disclosure of each of which is incorporated herein by reference for all purposes.

### BACKGROUND

1. Field

The following description relates to an optical pickup and an optical information storage medium system employing the same, and more particularly, to an optical pickup including a plurality of light sources emitting lights of different wavelengths and one light-receiving unit, and an optical information storage medium system employing the optical pickup.

2. Description of the Related Art

An optical recording and/or reproducing apparatus records and/or reproduces data on and/or from an optical disc using a laser beam and a light spot focused by an objective lens. In the optical recording and/or reproducing apparatus, recording capacity depends on the size of the light spot. The size of the light spot depends on a wavelength λ of the laser beam used and a numerical aperture (NA) of the objective lens as expressed in Equation 1.

Focused Light spot diameter∞λ/NA (1)

Accordingly, a short wavelength light source such as a blue laser and an objective lens having a high NA are required to reduce the size of a light spot focused on an optical disc so as to achieve high density of the optical disc.

A Blu-ray Disc (BD) which has a single surface capacity of about 25 GB and uses a light source having a wavelength of about 405 nm, an objective lens having an NA of 0.85, and an optical disc having a thickness (which refers to a distance from a light incidence surface to an information storage surface and corresponds to a thickness of a protective layer herein) of about 0.1 mm has been suggested. Also, a high definition digital versatile disc (HD DVD) which has a capacity of about 15 GB and uses a light source having the same wavelength as that of the light source of a BD, an objective lens having an NA of 0.65, and an optical disc having a thickness (which refers to a distance from a light incidence surface to an information storage surface and corresponds to a thickness of a substrate herein) of 0.6 mm, has been suggested.

An optical pickup capable of reproducing data from a high-density optical disc such as a BD or a HD DVD and an information storage medium system employing the optical pickup are required to be compatibly used for existing DVDs and CDs.

Thus, a compatible optical pickup used for a high-density optical disc includes a blue light source for a BD or HD DVD, a red light source for a DVD, and an infrared light source for a CD. The compatible optical pickup also includes a photodetector which receives light reflected from an information storage medium to detect reproduced and servo signals.

The number of light-receiving elements in the compatible optical pickup should be minimized to make the compatible optical pickup compact. For example, if the compatible optical pickup includes three light sources emitting lights having different wavelengths and one light-receiving element, the compatible optical pickup may be made compact.

However, if a compatible optical pickup including a plurality of light sources emitting lights having different wavelengths uses one light-receiving element, a focal length of light advancing through a detection lens toward the light-receiving element varies according to the wavelength due to aberration of the detection lens. Thus, a spot of light received on the light-receiving element is defocused. A focus servo signal is offset due to the defocus of the spot of light. As a result, a reproduced signal deteriorates.

### SUMMARY

An aspect provides a compatible optical pickup which includes a plurality of light sources and one light-receiving element and is capable of preventing offset generation of a focus servo signal by correcting a defocus of light advancing toward the light-receiving element due to a variation of a focal length according to the wavelength of the light, and an optical information storage medium system employing the compatible optical pickup.

According to an aspect, there is provided a compatible optical pickup including: a short wavelength light source emitting a short wavelength light suitable for a high-density information storage medium; a low-density optical system emitting a long wavelength light suitable for a low-density information storage medium; an objective lens focusing lights incident from the short wavelength light source and the low-density optical system onto an information storage medium; a single photo-detector (PD) receiving short and long wavelength lights reflected from the information storage medium to detect a reproduction signal and a focus error signal; a detection lens focusing the short and long wavelength lights reflected from the information storage medium as a light spot having an appropriate size onto the single PD; a first collimating lens positioned on an optical path of a light reflected from the information storage medium, between the objective lens and the single PD; and a driving unit adjusting a position of the first collimating lens along an optical axis according to a wavelength of a light advancing toward the single PD to reduce an offset of a focus error signal occurring due to chromatic aberration according to wavelength.

According to another aspect, the low density optical system may include first and second long wavelength light sources respectively emitting first and second long wavelength lights suitable for first and second low-density information storage media having different thicknesses; and an optical path combiner combining optical paths of the first and second long wavelength lights emitted from the first and second long wavelength lights.

According to another aspect, the high-density information storage medium may be at least one of a Blu-ray disc (BD) standard information storage medium and a high definition digital versatile disc (HD DVD) standard information storage medium. The first and second low-density information storage media may be a DVD standard information storage medium and a compact disc (CD) standard information storage medium, respectively. The short wavelength light for the high-density information storage medium may be a blue light, and the first and second long wavelength lights for the low-density information storage medium may be red and infrared lights, respectively.

According to another aspect, the compatible optical pickup may further include a hologram element disposed on an optical path between the long wavelength light source and the objective lens to diffract a long wavelength light in 0^{th}-order and 1^{st}-order, focus the 0^{th}-order diffraction light as a light spot onto a BD standard information storage medium, and focus the 1^{st}-order diffraction light as a light spot onto a HD DVD standard information storage medium.

According to another aspect, the hologram element may have wavelength selectivity to diffract the long wavelength light in 0^{th}-order and 1^{st}-order and transmit the long wavelength light.

According to another aspect, the compatible optical pickup may further include a correcting element disposed on an optical path between the low-density optical system and the objective lens to correct spherical aberration occurring when the first and second low-density information storage media are employed.

According to another aspect, the correcting element may have wavelength selectivity to correct spherical aberrations suitable for the first and second long wavelength lights when the first and second low-density information storage media are employed.

According to another aspect, the compatible optical pickup may further include a correcting element disposed on an optical path between the low-density optical system and the objective lens to correct spherical aberrations occurring when the first and second low-density information storage media are employed.

According to another aspect, the correcting element may have wavelength selectivity to correct spherical aberrations suitable for the first and second long wavelength lights when the first and second low-density information storage media are employed.

According to another aspect, the high-density information storage medium may be a BD standard information storage medium or a HD DVD standard information storage medium.

According to another aspect, the low-density optical system may include a long wavelength light source emitting a long wavelength light suitable for one of a DVD and a CD.

According to another aspect, the high-density information storage medium may include the BD standard information storage medium and the HD DVD standard information storage medium, and the compatible optical pickup may further include a hologram element disposed on an optical path between the long wavelength light source and the objective lens to diffract a long wavelength light in 0^{th}-order and 1^{st}-order, focus the 0^{th}-order diffraction light as a light spot onto a BD standard information storage medium, and focus the 1^{st}-order diffraction light as a light spot onto a HD DVD standard information storage medium.

According to another aspect, the hologram element may have wavelength selectivity to diffract the long wavelength light in 0^{th}-order and 1^{st}-order and straightly transmit the long wavelength light.

According to another aspect, the compatible optical pickup may further include a first optical path changer changing an optical path of lights emitted from the long wavelength light source and the low-density optical system; and a second optical path changer allowing a long wavelength light emitted from the long wavelength light source to advance toward the first optical path changer and short and long wavelength lights reflected from the information storage medium to advance toward the single PD.

According to another aspect, the compatible optical pickup may further include a wave plate changing polarization of a light incident on an optical path between the first optical path changer and the objective lens, wherein the first optical path changer includes a trichroic prism which transmits or reflects the long wavelength light according to a polarization state and proceeds the long wavelength light advancing from the second optical path changer toward the objective lens from the information storage medium toward the same optical path, and the second optical path changer includes a trichroic prism which transmits or reflects the long wavelength light according to a polarization state and directs the long wavelength light toward the single PD.

According to another aspect, the first optical path changer may include a trichroic prism which transmits and reflects the long wavelength light at a predetermined rate and directs a long wavelength light, which advances from the second optical path changer toward the objective lens, from the information storage medium toward the same optical path. The second optical path changer may include a tricolor prism which transmits and reflects the long wavelength light at a predetermined rate and directs the long wavelength light toward the single PD.

According to another aspect, there is provided an optical information storage medium system including: an optical pickup moving in a radial direction of an information storage medium to record and/or reproduce information on and/or from the information storage medium; and a controller controlling the optical pickup, wherein the optical pickup is the compatible optical pickup.

Other features and aspects may be apparent from the following detailed description, the drawings, and the claims.

### BRIEF DESCRIPTION OF THE DRAWINGS

FIG. 1 illustrates a schematic optical configuration of a compatible optical pickup used for a high-density information storage medium such as a Blu-ray disc (BD) or a high definition digital versatile disc (HD DVD), a DVD, and a compact disc (CD), according to an embodiment.

FIG. 2 is a graph illustrating a focus error signal and a radio frequency (RF) signal (a sum signal) detected from a BD when a first collimating lens of FIG. 1 is placed in a position in which a focus offset is “0” to obtain a good focus error signal with respect to the BD.

FIGS. 3A and 3B are graphs illustrating focus error signals and RF (sum) signals detected from a DVD and a CD when the first collimating lens of FIG. 1 is fitted to be suitable for a BD.

FIGS. 4A and 4B are graphs illustrating focus error signals and RF (sum) signals detected from a DVD and a CD after a position of the first collimating lens of FIG. 1 is adjusted to positions P1 and P2 illustrated in FIG. 1.

FIG. 5 illustrates a schematic optical structure of a compatible optical pickup according to another embodiment.

FIG. 6 illustrates a schematic structure of an optical information storage medium system employing a compatible optical pickup according to an embodiment.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

The compatible optical pickup according to an aspect includes a plurality of light sources including a short wavelength light source emitting light having a short wavelength appropriate for a high-density information storage medium such as a Blu-ray disc or a high definition digital versatile disc (HD DVD) and a long wavelength light source emitting light having a long wavelength appropriate for a low-density information storage medium such as a DVD and/or a compact disc (CD). The compatible optical pickup according to an aspect also uses a single photodetector which receives a short wavelength light and a long wavelength light reflected from an information storage medium to detect a reproducing signal (RF signal) and a focus error signal. In other words, the low-density information storage medium uses an independent light-transmitting part and shares a light-receiving part with the high-density information storage medium. Also, a light transmitting part for the BD or the HD DVD/uses the same signal collimating lens.

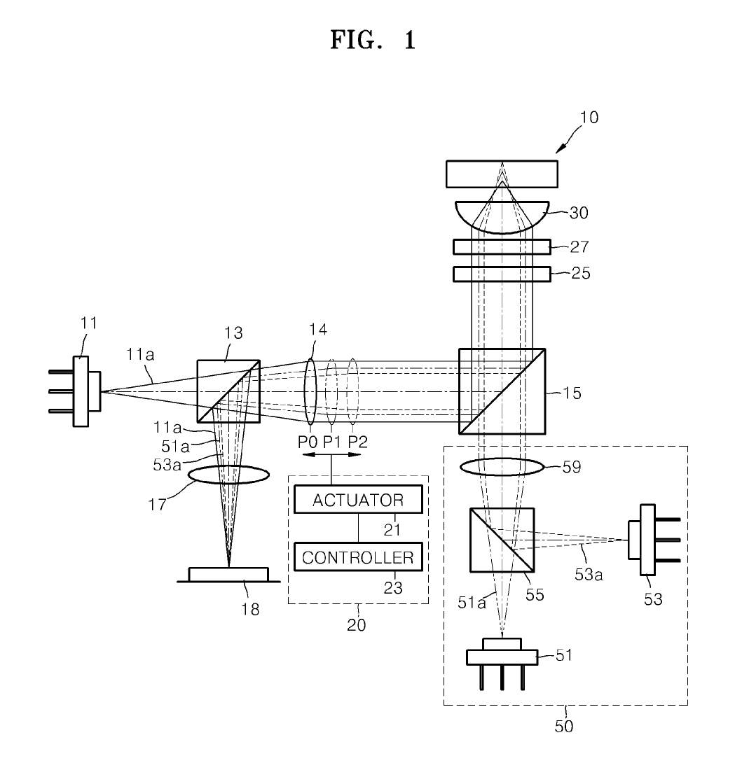

FIG. 1 illustrates a schematic optical configuration of a compatible optical pickup used for a high-density information storage medium such as a Blu-ray disc (BD) and/or a high definition digital versatile disc (HD DVD), a DVD, and a compact disc (CD), according to an embodiment. Referring to FIG. 1, the compatible optical pickup according to the present embodiment includes a short wavelength light source 11, a low-density optical system 50, an objective lens 30, a single photodetector (PD) 18, a detection lens 17, a first collimating lens 14, and a driving unit 20. The short wavelength light source 11 emits a short wavelength light 11a appropriate for a high-density information storage medium. The low-density optical system 50 emits a long wavelength light 51a appropriate for a low-density information storage medium. The objective lens 30 focuses the short wavelength light 11a incident from the short wavelength light source 11 and the long wavelength light 51a incident from the low-density optical system 50 on an information storage medium 10. The single PD 18 receives the short wavelength light 11a and the long wavelength light 51a reflected from the information storage medium 10 to detect a reproducing signal and a focus error signal. The detection lens 17 focuses the reflected short wavelength light 11a and the long wavelength light 51a as a light spot of appropriate size onto the single PD 18. The first collimating lens 14 is positioned on a path of light reflected from the information storage medium 10 between the objective lens 30 and the single PD 18. The driving unit 20 adjusts the position of the first collimating lens 14 according to a wavelength of light irradiated onto the information storage medium 10.

The compatible optical pickup of the present embodiment may further include first and second optical path changers 15 and 13. The first optical path changer 15 changes optical paths of the short wavelength light 11a and the long wavelength light 51a emitted from the short wavelength light source 11 and the low-density optical system 50, respectively. The second optical path changer 13 allows the short wavelength light 11a emitted from the short wavelength light source 11 to advance toward the first optical path converter 15 and the short wavelength light 11a and first and second long wavelength lights 51a and 53a reflected from the information storage medium 10 to advance toward the single PD 18.

The high-density information medium may be a BD standard information storage medium (hereinafter referred to as a BD) having a thickness of about 0.1 mm and a HD DVD standard information storage medium (hereinafter referred to as a HD DVD) having a thickness of about 0.6 mm.

The short wavelength light source 11 emits a blue light appropriate for the high-density information storage medium, i.e., the BD or HD DVD. The short wavelength light source 11 may include a semiconductor laser which emits a blue laser beam having a wavelength of about 400 nm, preferably, 405 nm.

The objective lens 30 focuses incident light onto the information storage medium 10. The objective lens 30 may be designed to be optimized for a high-density information storage medium, i.e., a BD. In other words, the objective lens 30 may be designed to form a light spot optimal for a BD having a thickness of about 0.1 mm, an effective numerical aperture (NA) of about 0.85 and light having a wavelength of about 400 nm.

Alternatively, the compatible optical pickup according to the present embodiment may be configured to be compatible with an HD DVD and low-density information storage media such as a DVD and a CD. In this case, the objective lens 30 may be formed to form a light spot optimal for the HD DVD having a thickness of about 0.6 mm, an effective NA of about 0.65 and light having a wavelength of about 40 nm.

The low-density optical system 50 may include first and second long wavelength light sources 51 and 53 and an optical path combiner 55. The first and second long wavelength light sources 51 and 53 respectively emit the first and second long wavelength lights 51a and 53a appropriate for first and second low-density information storage mediums having different thicknesses. The optical path combiner 55 combines the first and second long wavelength lights 51a and 53a so that the first and second long wavelength lights 51a and 53a travel along the same optical path. The low-density optical system 50 may further include a second collimating lens 59 which collimates the first and second long wavelength lights 51a and 53a incident from the first and second long wavelength light sources 51 and 53 on an optical path between the optical path combiner 55 and the first optical path converter 15.

The first low-density information storage medium may be a DVD standard information storage medium (hereinafter referred to as a DVD), and the second low-density information storage medium may be a CD standard information storage medium (hereinafter referred to as a CD). In this case, the first long wavelength light source 51 may emit a red light, e.g., a red light having a wavelength of about 650 nm. Also, the second long wavelength light source 53 may emit an infrared light, e.g., an infrared light having a wavelength of about 780 nm. In other words, the first long wavelength light 51a may be a red light appropriate for a DVD, and the second long wavelength light 53a may be an infrared light appropriate for a CD.

The optical path combiner 55 may be a dichroic prism which transmits the first long wavelength light 51a emitted from the first long wavelength light source 51 and reflects the second long wavelength light 53a emitted from the second long wavelength light source 53.

The compatible optical pickup of the present embodiment may further include a correcting element 27 which is positioned on an optical path between the low-density optical system 50 and the objective lens 30, preferably, between the first optical path changer 15 and the objective lens 30, to correct spherical aberration occurring when a DVD and a CD are utilized.

The correcting element 27 may have wavelength selectivity to achieve spherical aberration corrections appropriate for the first and second long wavelength lights 51a and 53a when the DVD and the CD are used. In other words, the correcting element 27 may achieve the spherical aberration correction appropriate for the first long wavelength light 51a during use of the DVD and the spherical aberration correction appropriate for the second long wavelength light 53a during use of the CD. In addition, the correcting element 27 may be provided to transmit the short wavelength light 11a.

The correcting element 27 may be a hologram which has wavelength selectivity to correct spherical aberration occurring during the use of a DVD and a CD.

The first and second optical path changers 15 and 13 may include trichroic prisms.

As illustrated in FIG. 1, a wave plate 25, e.g., a quarter wave plate, is provided to change polarization of light incident on an optical path between the first optical path changer 15 and the objective lens 30

When the wave plate 25 is provided, the trichroic prism used as the first optical path changer 15 may be formed to transmit or reflect the first and second long wavelengths lights 51a and 53a according to polarization and allow the short wavelength light 11a advancing from the second optical path changer 13 toward the objective lens 30 to be reflected from the information storage medium 10 and then to move toward the second optical path changer 13 through the same optical path. In other words, the first optical path changer 15 may use a trichroic prism formed to operate as a polarization beam splitter for the first and second long wavelength lights 51a and 53a and to reflect the short wavelength light 11a.

Also, when the wave plate 25 is provided, the second optical path changer 13 may be used to transmit or reflect the short wavelength light 11a according to polarization and reflect the first and second long wavelength lights 51a and 53a toward the single PD 18. In other words, the second optical path changer 13 may use a trichroic prism as a polarization beam splitter for the short wavelength light 11a and to reflect long wavelength lights.

Alternatively, the compatible optical pickup of the present embodiment may not include the wave plate 25. When the compatible optical pickup does not include the wave plate 25, the trichroic prism used as the first optical path changer 15 may be formed to transmit and reflect the first and second long wavelength lights 51a and 53a at a predetermined rate and allow the short wavelength light 11a advancing from the second optical path changer 13 toward the objective lens 30 to be reflected from the information storage medium 10 and then advance toward the second optical path changer 13 through the same optical path. In other words, the first optical path changer 15 may use a trichroic prism formed to operate as a general beam splitter for the first and second long wavelength lights 51a and 53a and to reflect the short wavelength light 11a.

Also, when the compatible optical pickup does not include the wave plate 25, the second optical path changer 13 may be formed to transmit and reflect the short wavelength light 11a at a predetermined rate and to reflect the first and second long wavelength lights 51a and 53a toward the single PD 18. In other words, the second optical path converter 13 may use a trichroic prism formed to operate as a general beam splitter for the short wavelength light 11a and to reflect the long wavelength lights.

An illustration of the compatible optical pickup not including the wave plate 25 is omitted since such feature could be understood from FIG. 1. Thus, an illustration of this case will be omitted.

The single PD 18 receives the short wavelength light 11a and the first and second long wavelength lights 51a and 53a reflected from the information storage medium 10 in order to detect a reproduction signal (RF signal) and a servo signal, e.g., focus error signals. For example, the single PD 18 may include quadrant light-receiving areas to detect a focus error signal using an anastigmatic method.

The detection lens 17 may be disposed in front of the single PD 18, i.e., on an optical path between the second optical path changer 13 and the single PD 18. The detection lens 17 may be a cylinder lens used to detect a focus error signal using an astigmatic method.

It is assumed that a light-receiving optical system, i.e., the first collimating lens 14, the second optical path changer 13, the detection lens 17, and the single PD 18, are optimized for use with the short wavelength light 11a which is reflected from a high-density information storage medium and directed toward the single PD 18 in the compatible optical pickup according to the present embodiment. If a DVD or a CD is used, the first long wavelength light 51a reflected from the DVD toward the single PD 18 or the second long wavelength light 53a reflected from the CD toward the single PD 18 is defocused due to chromatic aberration generated by the detection lens 17. Thus, offset is generated in a focus error signal. The focus offset due to the chromatic aberration is removed by adjusting the position of the first collimating lens 14 according to the type of information storage medium and the wavelength used.

The first collimating lens 14 is positioned on an optical path between the objective lens 30 and the single PD 18, more preferably, between the first and second optical path changer 15 and 13, on the optical path of the short wavelength light 11a and on the optical path of the long wavelength lights reflected from the information storage medium 10. The first collimating lens 14 collimates the short wavelength light 11a from the long wavelength light source 11 toward the objective lens 30. The position of the first collimating lens 14 is adjusted by the driving unit 20 according to a wavelength of a light reflected from the information storage medium 10 through the detection lens 17 and toward the single PD 18 without being defocused.

The driving unit 20 adjusts the position of the first collimating lens 14 along an optical axis according to a wavelength of a light moving to the single PD 18 in order to reduce the offset of the focus error signal caused by chromatic aberration.

The driving unit 20 includes an actuator 21 and a controller 23. The actuator 21 moves the first collimating lens 14 along the optical axis. The controller 23 drives the actuator 21 to change the position of the first collimating lens 14 according to a wavelength of a light in order to reduce the offset of the focus error signal in the single PD 18 due to chromatic aberration.

As described above, the first collimating lens 14 and the detection lens 17 may be placed in the apparatus so that the short wavelength light 11a is optimally focused on the single PD 18. Also, the position of the first collimating lens 14 is adjusted by the driving unit 20 according to a type of information storage medium used and a wavelength of a light irradiated on the information storage medium.

It is assumed that an optimal position of the first collimating lens 14 is “P0: which is a position of the CL for BD or HD DVD,” a position “P1: which is a position of the CL for a DVD,” and “P2: which is a position of the CL for a CD” as shown in FIG. 1. The optimal position is to remove an offset of a focus error signal caused by chromatic aberration occurring during recording and/or reproduction with respect to a high-density information storage medium such as a BD or a HD DVD, a DVD, or a CD.

The operation of the compatible optical pickup of the present embodiment, the detection of a focus error signal and the reproduction signal depending on the operation of the compatible optical pickup during employment of a high-density information storage medium (BD or HD DVD), a DVD, and a CD will now be described with reference to FIGS. 1 and 2 through 4B.

When the information storage medium 10 is a BD and the short wavelength light source 11 emits the short wavelength light 11a, the first collimating lens 14 is kept in the position P0.

The short wavelength light 11a emitted from the short wavelength light source 11 is transmitted through the second optical path changer 13, collimated by the first collimating lens 14, reflected from the first optical path changer 15, and is incident on the objective lens 30 after passing through the wave plate 25. The short wavelength light 11a is focused on the information storage medium 10, e.g., the BD, by the objective lens 30. The short wavelength light 11a reflected from the BD is collimated by passing through the objective lens 30, and is changed polarization while passing through the wave plate 25 to be orthogonal to an incident light. The short wavelength light 11a is thereafter reflected from the first optical path changer 15 and converged by the first collimating lens 14. The converged short wavelength light 11a is reflected from the second optical path converter 13, converged by the detection lens 17, and focused on the single PD 18. A reproduction signal and a servo signal are obtained from a signal detected by the single PD 18.

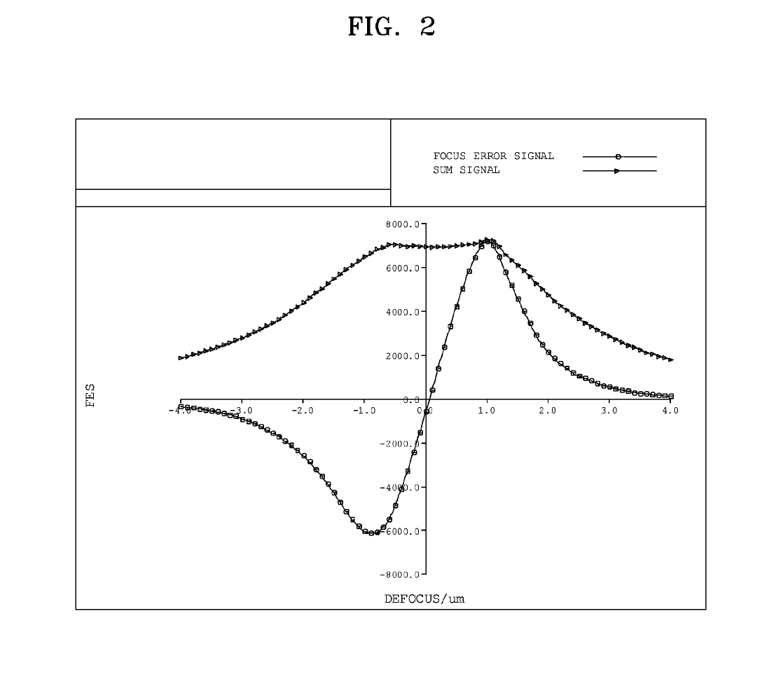

Here, the first collimating lens 14 is located in the position P0 in which a focus offset is “0” in order to obtain a good focus error signal for a BD. FIG. 2 is a graph illustrating a focus error signal and a reproduction signal (RF signal: sum signal) detected with respect to a BD. As shown in FIG. 2, an offset of the focus error signal is approximately “0” for the BD. Thus, a focus servo operation can be easily performed, and a good reproduction signal can be detected.

When the information storage medium 10 is a DVD and the first long wavelength light source 51 is operated to emit the first long wavelength light 51a, the first collimating lens 14 is controlled by the driving unit 20 to move to the position P1.

When the information storage medium 10 is a CD and the second long wavelength light source 53 is operated to emit the second long wavelength light 53a, the second collimating lens 14 is controlled by the driving unit 20 to move to the position P2.

When a DVD or a CD is employed as the information storage medium 10, the first or second long wavelength light 51a or 53a emitted from the first or second long wavelength light source 51 or 53 is transmitted through or is reflected by the optical path combiner 55 and is incident onto the second collimating lens 59. The first or second long wavelength light 51a or 53a is then collimated by the second collimating lens 59, is transmitted through the first optical path changer 15, is incident onto the objective lens 30 through the wave plate 25 and the correcting element 27, and is focused onto the DVD or CD by the objective lens 30.

The first or second long wavelength light 51a or 53a reflected from the DVD or the CD is transmitted through the objective lens 30 and has changed polarization while passing through the wavelength plate 25 to be orthogonal to an incident light. The first or second long wavelength light 51a or 53a is reflected from the first optical path changer 15 and converged by the first collimating lens 14. The converged first or second long wavelength light 51a or 53a is reflected from the second optical path changer 13, converged by the detection lens 17, and focused onto the single PD 18. A reproduction signal and a servo signal for the DVD or the CD are obtained from a signal detected by the single PD 18.

When a BD (or a HD DVD), a DVD, or a CD is used, all lights use the first collimating lens 14 and the detection lens 17 of a light-receiving part. Thus, if positions of the first collimating lens 14 and the detection lens 17 are fixed, due to the change of focal length according to the wavelength, a defocus occurs, and thus offset in a focus error signal is generated.

When the first collimating lens 14 is placed in a position in which a focus offset is “0” in order to obtain a good focus error signal for a BD (or a HD DVD), an offset of 0.3 μm is generated during the use of a DVD but an offset of 0.2 μm is generated during the use of a CD in a focus error signal.

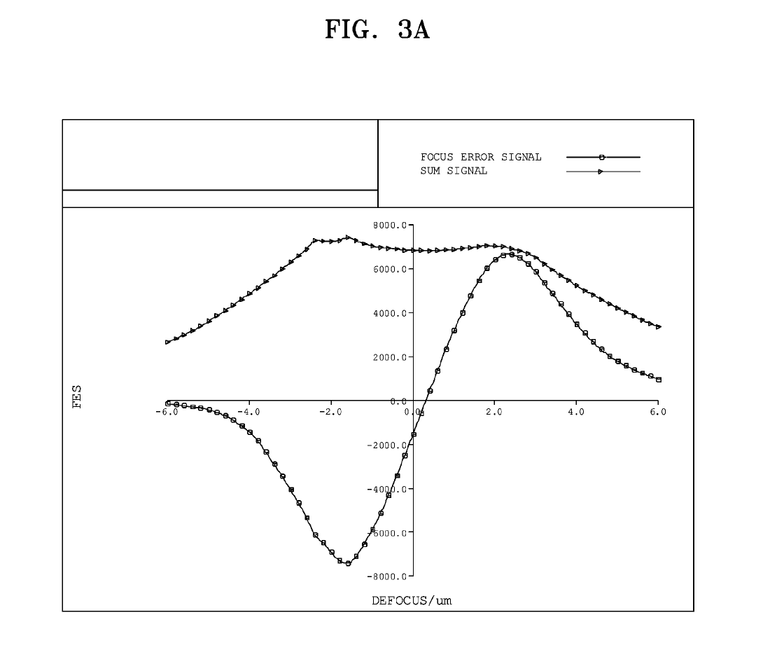

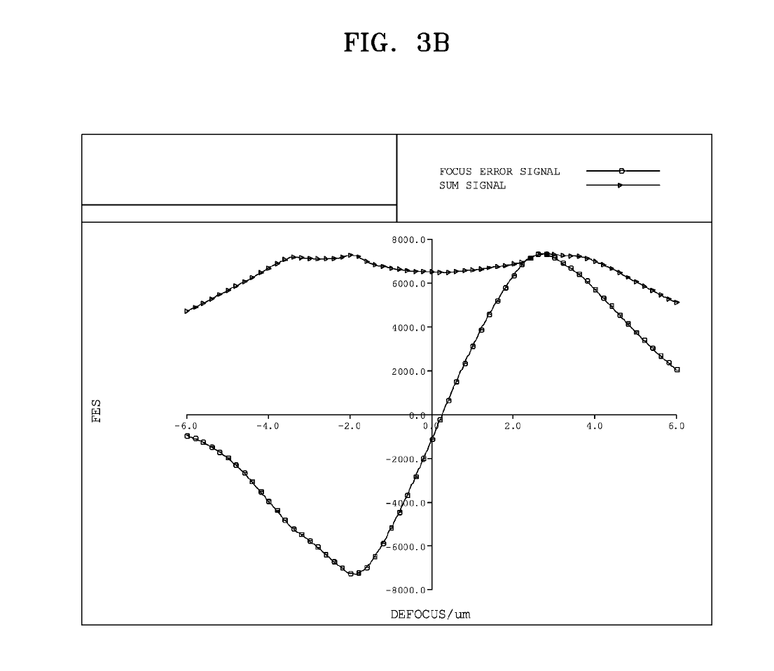

FIGS. 3A and 3B are graphs illustrating focus error signals and reproduction signals (RF signals: sum signals) detected with respect to a DVD and a CD when the first collimating lens 14 is positioned for a BD.

If a focus offset occurs, a reproduction signal may deteriorate.

The focus offset caused by chromatic aberration can be corrected by adjusting the position of the first collimating lens 14 by controlling the driving unit 20 as described in an embodiment.

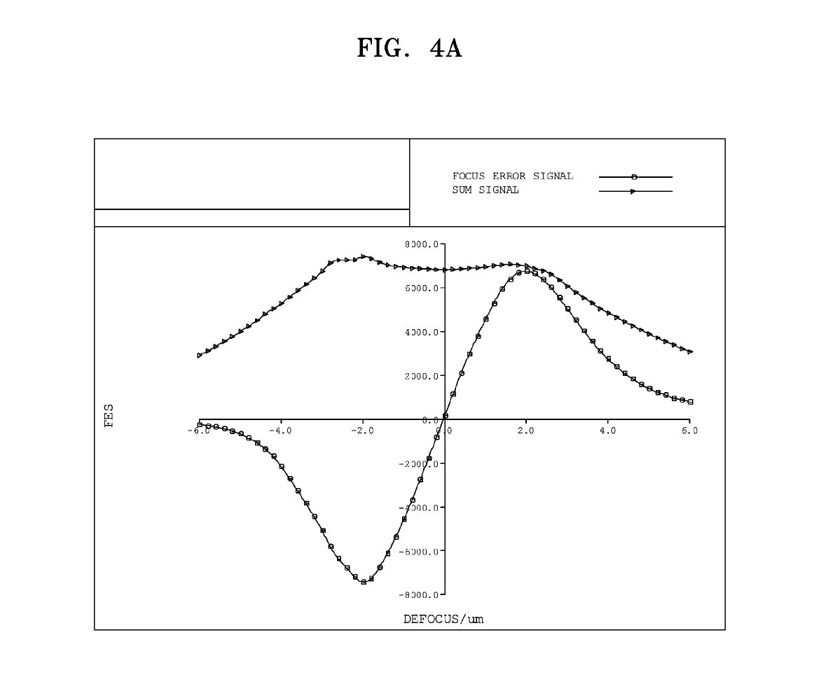

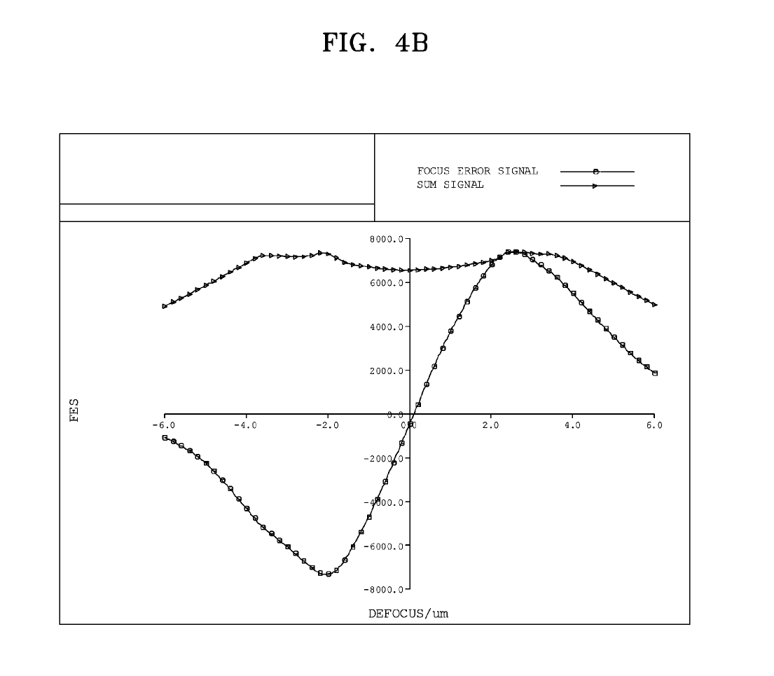

FIGS. 4A and 4B are graphs illustrating focus error signals and reproduction signals (RF signals: sum signals) detected with respect to a DVD and a CD after the position of the first collimating lens 14 is adjusted to P1 and P2.

As shown in FIGS. 4A and 4B, if the position of the first collimating lens 14 is adjusted, focus offsets to the DVD and the CD can be corrected. Here, an adjustment length of the first collimating lens 14 for the DVD for obtaining the result illustrated in FIG. 4A, i.e., a distance between the positions P0 and P1, was about 23 μm. An adjustment length of the first collimating lens 14 for the CD for obtaining the result illustrated in FIG. 4B, i.e., a distance between the positions P0 and P2, was about 60 μm.

If the position of the first collimating lens 14 on the optical path of the light-receiving part is adjusted by the driving unit 20, although the short wavelength light 11a and the long wavelength lights are detected using the single PD 18, an offset of a focus error signal of the CD and/or DVD caused by a defocus generated by variation of focal length is prevented. As a result, good focus error signals are detected from lights having three different wavelengths for a BD (or HD DVD), a DVD, and a CD. Therefore, a good focus servo operation can be performed, and a good reproduction signal can be detected.

The compatible optical pickup according to the present embodiment can be used with high-density information storage media, such as a BD and a HD DVD, a DVD, and a CD.

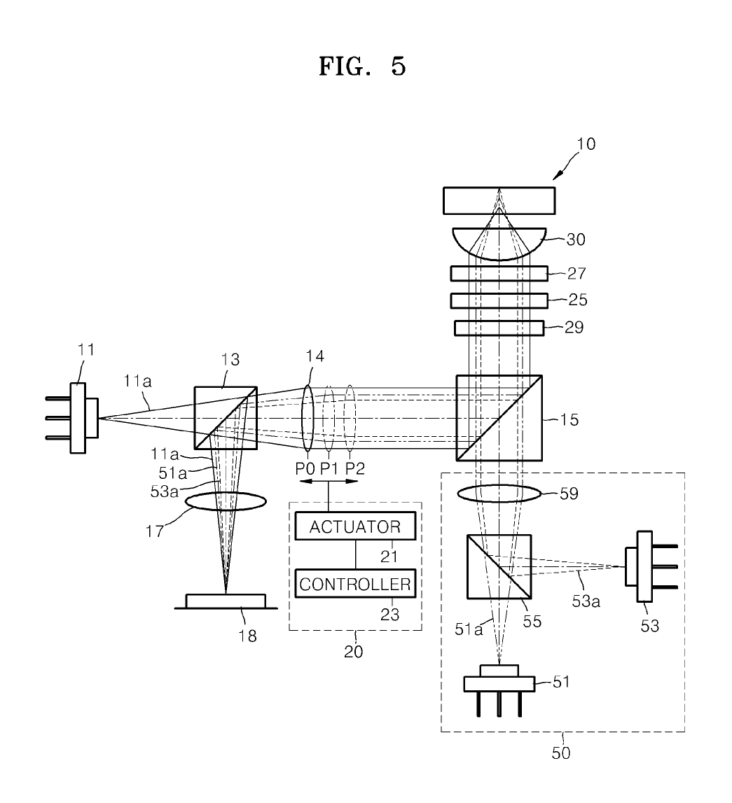

FIG. 5 illustrates a schematic optical configuration of a compatible optical pickup according to another embodiment. Unlike the compatible optical pickup of the previous embodiment, the compatible optical pickup of the present embodiment illustrated in FIG. 5, further includes a hologram element 29 placed on an optical path between a short wavelength light source 11 and an objective lens 30 to be compatibly used with a BD and a HD DVD. The reference numerals of FIG. 5 are the same reference numerals as those of FIG. 1, and thus detailed descriptions thereof will be omitted herein.

The hologram element 29 diffracts a short wavelength light 11a emitted from the short wavelength light source 11 in 0^{th}-order and 1^{st}-order. Here, the 0^{th}-order diffraction light may be focused as a light spot onto a BD, and the 1^{st}-order diffraction light may be focused as a light spot onto a HD DVD.

The hologram element 29 may be disposed between a first optical path changer 15 and an objective lens 30 as illustrated in FIG. 5. In this case, first and second long wavelength lights 51a and 53a emitted from first and second long wavelength light sources 51 and 53 respectively are transmitted through the hologram element 29. Thus, the hologram element 29 may be formed to have wavelength selectivity so as to diffract the short wavelength light 11a in 0^{th}-order and 1^{st}-order and straightly transmit the first and second long wavelength lights 51a and 53a.

As illustrated in FIGS. 1 and 5, the compatible optical pickup according to the described embodiments may include the low-density optical system 50 having long wavelength light sources for DVD and CD. However, the embodiments are not limited thereto. The low-density optical system 50 of the compatible optical pickups illustrated in FIGS. 1 and 5 may include only one long wavelength light source which emits a long wavelength light suitable for a DVD or a CD. For example, the low-density optical system 50 may not include the optical path combiner 55 and the second long wavelength light source 53 (not shown).

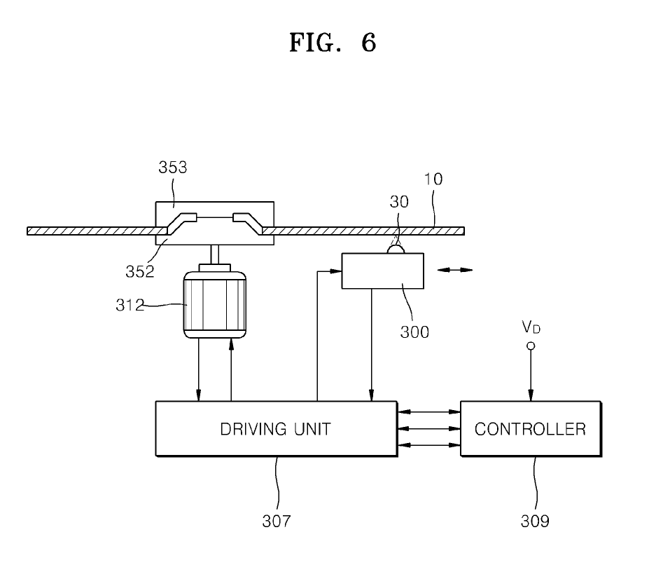

FIG. 6 illustrates a schematic structure of an optical information storage medium system employing a compatible optical pickup according to an embodiment. Referring to FIG. 6, the optical information storage medium system according to the present embodiment includes a spindle motor 312, an optical pickup 300, a driving unit 307, and a controller 309. The spindle motor 312 rotates an information storage medium 10. The optical pickup 300 is installed to move in a radial direction of the information storage medium 10 and records and/or reproduces information on and/or from the information storage medium 10. The driving unit 307 drives the spindle motor 312 and the optical pickup 300. The controller 309 controls focus, tracking, and/or tilt servos of the optical pickup 300. Here, reference numerals 352 and 353 denote a turntable and a clamp, respectively. The clamp 353 is used to chuck the information storage medium 10.

The optical pickup 300 may be one of the above-described embodiments.

Light reflected from the information storage medium 10 is detected and converted into an electrical signal by a single PD 18 of the optical pickup 300. The electrical signal is input to the controller 309 through the driving unit 307. The driving unit 307 controls a rotation speed of the spindle motor 312, amplifies an input signal, and drives the optical pickup 300. The controller 309 transmits at least one of focus, track, and tilt servo commands adjusted based on a signal input from the driving unit 307 to the controller 309 in order to realize at least one of focusing, tracking, and tilting operations of the optical pickup 300. The optical information storage medium system employing the compatible optical pickup according to an embodiment may be compatible with at least one of a BD and a HD DVD and at least one of a DVD and a CD.

As described above, a compatible optical pickup can include a plurality of light sources emitting lights having different wavelengths and a single PD. The position of a collimating lens on an optical path of a light reflected from an information storage medium toward the single PD can be adjusted to correct a defocus of a light moving toward the single PD, wherein the defocus is caused by a variation of a focal distance resulting from a wavelength of the light. Thus, an offset of a focus servo signal caused by chromatic aberration of a light-receiving part can be prevented.

Accordingly, good focus error signals can be detected using the single PD with respect to a plurality of information storage media having different formats and lights having wavelengths used for the plurality of information storage media. Thus, a good focus servo operation can be performed, and a good reproduction signal can be detected.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An optical pickup, comprising:
a short wavelength light source configured to emit a short wavelength light suitable for a high-density information storage medium;
a low-density optical system configured to emit a long wavelength light suitable for a low-density information storage medium;
an objective lens configured to focus lights incident from the short wavelength light source and the low-density optical system onto an information storage medium;
a single photodetector (PD) configured to receive the short and long wavelength lights reflected from the information storage medium to detect a reproduction signal and a focus error signal;
a detection lens configured to focus the short and long wavelength lights reflected from the information storage medium as a light spot comprising a size corresponding to a type of the information storage medium onto the single PD;
a first collimating lens positioned on an optical path of the short and long wavelength lights reflected from the information storage medium, between the objective lens and the single PD;
a driving unit configured to adjust a position of the first collimating lens along the optical path, according to a wavelength of the short and long wavelength lights advancing toward the single PD, to reduce an offset of a focus error signal caused by chromatic aberration; and
a hologram element disposed on an optical path between the short wavelength light source and the objective lens, the hologram element configured to:
diffract the short wavelength light in 0^{th}-order and 1^{st}-order;
focus the 0^{th}-order diffraction light as a light spot onto the BD (blue laser disc) standard information storage medium; and
focus the 1^{st}-order diffraction light as a light spot onto the HD DVD (high definition digital versatile disc) standard information storage medium.

2. The optical pickup of claim 1, wherein the hologram element comprises wavelength selectivity configured to:
diffract the long wavelength light in 0^{th}-order and 1^{st}-order; and
straightly transmit the long wavelength light.

3. The optical pickup of claim 1, further comprising a correcting element disposed on an optical path between the low-density optical system and the objective lens, the correcting element configured to correct spherical aberration occurring when the first and second low-density information storage media are employed.

4. The optical pickup of claim 3, wherein the correcting element comprises wavelength selectivity configured to correct spherical aberrations suitable for the first and second long wavelength lights when the first and second low-density information storage media are employed.

5. An optical pickup, comprising:
a short wavelength light source configured to emit a short wavelength light suitable for a high-density information storage medium;
a low-density optical system configured to emit a long wavelength light suitable for a low-density information storage medium;
an objective lens configured to focus lights incident from the short wavelength light source and the low-density optical system onto an information storage medium;
a single photodetector (PD) configured to receive the short and long wavelength lights reflected from the information storage medium to detect a reproduction signal and a focus error signal;
a detection lens configured to focus the short and long wavelength lights reflected from the information storage medium as a light spot comprising a size corresponding to a type of the information storage medium onto the single PD;
a first collimating lens positioned on an optical path of the short and long wavelength lights reflected from the information storage medium, between the objective lens and the single PD;
a driving unit configured to adjust a position of the first collimating lens along the optical path, according to a wavelength of the short and long wavelength lights advancing toward the single PD, to reduce an offset of a focus error signal caused by chromatic aberration; and
a hologram element disposed on an optical path between the short wavelength light source and the objective lens, the hologram element configured to:
diffract the short wavelength light in 0^{th}-order and 1^{st}-order;
focus the 0^{th}-order diffraction light as a light spot onto the BD standard information storage medium; and
focus the 1^{st}-order diffraction light as an light spot onto the HD DVD standard information storage medium,
wherein:
the high-density information storage medium comprises at least one of a BD (blue laser disc) standard information storage medium and a HD DVD (high definition digital versatile disc) standard information storage medium, and
the low-density optical system comprises a long wavelength light source configured to emit the long wavelength light suitable for one of a DVD (digital versatile disc) and a CD (compact disc),

6. The optical pickup of claim 5, wherein the hologram element comprises wavelength selectivity configured to:
diffract the long wavelength light in the 0^{th}-order and the 1^{st}-order; and
straightly transmit the long wavelength light.

7. An optical information storage medium system, comprising:
an optical pickup configured to move in a radial direction of an information storage medium to record and/or reproduce information on and/or from the information storage medium; and
a controller configured to control the optical pickup, the optical pickup comprising:
a short wavelength light source configured to emit a short wavelength light suitable for a high-density information storage medium;
a low-density optical system configured to emit a long wavelength light suitable for a low-density information storage medium;
an objective lens configured to focus lights incident from the short wavelength light source and the low-density optical system onto an information storage medium;
a single photodetector (PD) configured to receive the short and long wavelength lights reflected from the information storage medium to detect a reproduction signal and a focus error signal;
a detection lens configured to focus the short and long wavelength lights reflected from the information storage medium as a light spot comprising a size corresponding to a type of the information storage medium onto the single PD;
a first collimating lens positioned on an optical path of a light reflected from the information storage medium, between the objective lens and the single PD; and
a driving unit configured to adjust a position of the first collimating lens along the optical path, according to a wavelength of a light advancing toward the single PD, to reduce an offset of a focus error signal caused by chromatic aberration,
wherein the low-density optical system comprises:
first and second long wavelength light sources respectively configured to emit first and second long wavelength lights suitable for first and second low-density information storage media comprising different thicknesses; and
an optical path combiner configured to combine optical paths of the first and second long wavelength lights emitted from the first and second long wavelength light sources,
wherein:
the high-density information storage medium comprises at least one of a BD (blue laser disc) blue laser standard information storage medium and a high definition HD DVD (high definition digital versatile disc) standard information storage medium;
the first and second low-density information storage media comprise a DVD (digital versatile disc) standard information storage medium and a CD (compact disc) standard information storage medium, respectively;
the short wavelength light comprises a blue light; and
the first and second long wavelength lights comprise red and infrared lights, respectively,
wherein the compatible optical pickup further comprises a hologram element disposed on a light path between a short wavelength light source and the objective lens, the hologram element configured to:
diffract the short wavelength light in 0^{th}-order and 1^{st}-order;
focus the 0^{th}-order diffraction light as a light spot onto the BD standard information storage medium; and
focus the 1^{st}-order diffraction light as a light spot onto the HD DVD standard information storage medium.

8. The optical information storage medium system of claim 7, wherein the hologram element comprises wavelength selectivity configured to:
diffract the short wavelength light in the 0^{th}-order and the 1^{st}-order; and
straightly transmit the short wavelength light.

9. The optical information storage medium system of claim 7, further comprising a correcting element disposed on an optical path between the low-density optical system and the objective lens, the correcting element configured to correct spherical aberrations occurring when the first and second low-density information storage media are employed.

10. The optical information storage medium system of claim 9, wherein the correcting element comprises wavelength selectivity configured to correct spherical aberrations suitable for the first and second long wavelength lights when the first and second low-density information storage media are employed.

11. An optical information storage medium system, comprising:
an optical pickup configured to move in a radial direction of an information storage medium to record and/or reproduce information on and/or from the information storage medium; and
a controller configured to control the optical pickup, the optical pickup comprising:
a short wavelength light source configured to emit a short wavelength light suitable for a high-density information storage medium;
a low-density optical system configured to emit a long wavelength light suitable for a low-density information storage medium;
an objective lens configured to focus lights incident from the short wavelength light source and the low-density optical system onto an information storage medium;
a single photodetector (PD) configured to receive the short and long wavelength lights reflected from the information storage medium to detect a reproduction signal and a focus error signal;
a detection lens configured to focus the short and long wavelength lights reflected from the information storage medium as a light spot comprising a size corresponding to a type of the information storage medium onto the single PD;
a first collimating lens positioned on an optical path of a light reflected from the information storage medium, between the objective lens and the single PD; and
a driving unit configured to adjust a position of the first collimating lens along the optical path, according to a wavelength of a light advancing toward the single PD, to reduce an offset of a focus error signal caused by chromatic aberration,
wherein:
the high-density information storage medium comprises at least one of a BD (blue laser disc) standard information storage medium and a HD DVD (high definition digital versatile disc) standard information storage medium, and
the low-density optical system comprises a long wavelength light source configured to emit a long wavelength light suitable for one of a DVD (digital versatile disc) and a CD (compact disc),
wherein the high-density information storage medium comprises at least one of a BD (blue laser disc) standard information storage medium and a HD DVD (high definition digital versatile disc) standard information storage medium, and
wherein the low-density optical system comprises a long wavelength light source configured to emit a long wavelength light suitable for one of a DVD (digital versatile disc) and a CD (compact disc),
wherein the high-density information storage medium comprises the BD standard information storage medium and the HD DVD standard information storage medium, and
wherein the compatible optical pickup further comprises a hologram element disposed on alight path between the long wavelength light source and the objective lens, the hologram element being configured to:
diffract a long wavelength light in 0^{th}-order and 1^{st}-order;
focus the 0^{th}-order diffraction light as a light spot onto a BD standard information storage medium, and
focus the 1^{st}-order diffraction light as an light spot onto a HD DVD standard information storage medium.

12. The optical information storage medium system of claim 11, wherein the hologram element comprises wavelength selectivity configured to:
diffract the long wavelength light in 0^{th}-order and 1^{st}-order; and
straightly transmit the long wavelength light.
